(19) United States
(12) Patent Application Publication
(10) Pub. No.: US 2024/0117902 A1
(43) Pub. Date: Apr. 11, 2024

(54) INTERNALLY HEATED HOSE WIRE IMPREGNATION

(71) Applicant: Graco Minnesota Inc., Minneapolis, MN (US)

(72) Inventors: Joseph E. Tix, Hastings, MN (US); Stephen P. Schneider, Blaine, MN (US)

(21) Appl. No.: 18/270,347

(22) PCT Filed: Dec. 29, 2021
(86) PCT No.: PCT/US2021/065518

§ 371 Date: Jun. 29, 2023

Related U.S. Application Data
(60) Provisional application No. 63/132,147, filed on Dec. 30, 2020.

(51) Int. Cl. F16L 11/127; F16L 53/38

(52) U.S. Cl. CPC F16L 11/127; F16L 53/38

(57) ABSTRACT

An internally heated hose (12) comprising: a multi-layer flexible heating element (2) comprising a sealant material disposed between layers of the multi-layer flexible heating element; a hose core (20) through which the multi-layer flexible heating element extends; and a fitting (14) coupled to the hose core and through which the multi-layer flexible heating element extends, the fitting configured to secure the multi-layer flexible heating element in place and mechanically seal an outer surface of the multi-layer flexible heating element.

### BACKGROUND

The present invention relates generally to heated fluid delivery systems and more particularly to internally heated hoses.

The present invention can be particularly suited to applications requiring delivery of a fluid through a hose exposed to ambient temperatures that can adversely reduce a temperature of the fluid in the hose, rendering the fluid ineffective for the particular application. For instance, the application of spray foam insulation can involve pumping reactive fluids through one or more hoses exposed to varying ambient temperatures. In some low temperature environments, the physical properties of the fluids can be changed during the application process, causing the application to fail or resulting in the application of an ineffective product. Flexible heating elements, such as thermally conductive wire, can be provided in the hose core to heat the fluid. Internal heating elements are often sheathed in one or more protective layers, which can provide a leakage pathway for fluids in the hose. Fluids can enter the heating element at interfaces between protective layers and can be transmitted through the heating element out of the hose at locations of hose fittings and electrical connections. Mechanisms for eliminating such leakage pathways are needed.

### SUMMARY

An internally heated hose includes a multi-layer flexible heating element including a sealant material disposed between layers of the multi-layer flexible heating element, a hose core through which the multi-layer flexible heating element extends, and a fitting coupled to the hose core and through which the multi-layer flexible heating element extends. The fitting is configured to secure the multi-layer flexible heating element in place and mechanically seal an outer surface of the multi-layer flexible heating element.

A flexible heating element for an internally heated hose includes a conductive wire, an insulating layer forming a sheath around the conductive wire, and a sealant material disposed between the conductive wire and the insulating layer to seal a leak path therebetween.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a perspective cross-sectional view of an internally heated hose with a multi-layer flexible heating element.

FIG. 2 is close-up cross-sectional view of the multi-layer flexible heating element of FIG. 1 with portions of a layered construction removed.

FIGS. 3A and 3B are close-up cross-sectional views of portions of the multi-layer flexible heating element of FIG. 2 with and without a sealant applied between layers of the multi-layer flexible heating element.

FIGS. 4A and 4B are close-up cross-sectional views of portions of the multi-layer flexible heating element of FIG. 2 with and without a sealant applied between further layers of the multi-layer flexible heating element.

FIGS. 5A and 5B are close-up cross-sectional views of portions of the multi-layer flexible heating element of FIG. 2 with and without a sealant applied between still further layers of the multi-layer flexible heating element.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

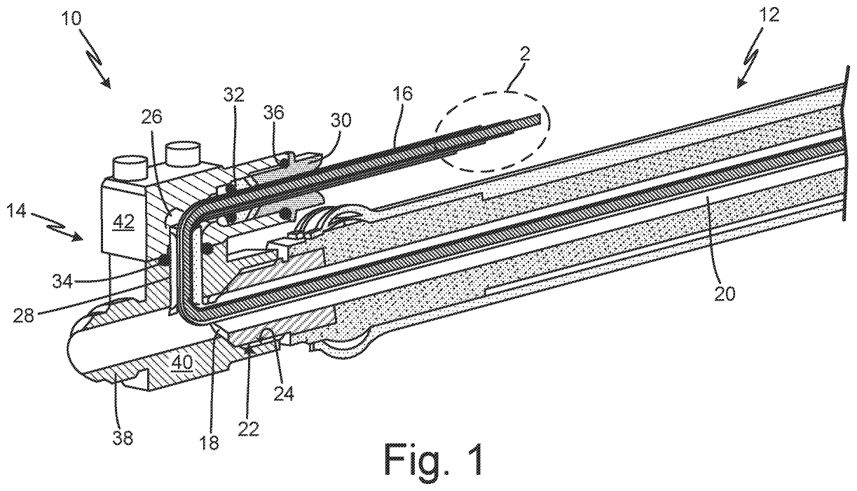

FIG. 1 is a perspective cross-sectional view of internally heated hose assembly 10. Internally heated hose assembly 10 includes hose 12, fitting 14, and flexible heating element 16. Hose 12 has inlet end 18, an opposite outlet end (not shown), and hose core 20. Fitting 14 is a connector and support structure configured to couple to inlet end 18 of hose 12 and to secure flexible heating element 16. Flexible heating element 16 is a resistive heating element that extends through fitting 14 into inlet end 18 of hose 12, through hose core 20, and out a fitting (not shown) at the opposite end of hose 12 similar to fitting 14. As shown in FIG. 1, hose 12 can include connection 22 and fitting 14 can include hose connection 24, passage 26, one or more retention mechanisms 28, 30, 32, one or more seals 34, 36, and fluid inlet connection 38.

Hose 12 can be formed in accordance with any construction known in the art and suitable for the delivery of a fluid. Inlet end 18 can include a threaded connection 22 or other mechanism capable of providing a sealed connection with fitting 14. The outlet end of hose 12 (not shown) can include a threaded connection or other suitable mechanism for coupling with a fluid delivery apparatus, additional hose section, or a whip hose.

Fitting 14 can include threaded hose connection 24 configured to mate with threaded connection 22 or other suitable mechanism for providing a sealed connection with hose inlet end 18. Fitting 14 can include fluid inlet connection 38 configured to connect to a fluid source (not shown). Fluid inlet connection 38 can be configured to align a passage through fluid inlet connection 38 with hose core 20. Fitting 14 can include passage 26 for flexible heating element 16. One or more retention mechanisms 28, 30, 32 can be used to position and retain flexible heating element 16 in passage 26. Retention mechanism 32 can be a mechanical sealing element, such as a compression seal, configured to seal an outer surface of flexible heating element 16 in fitting 14 and thereby prevent fluid from hose core 20 from leaking through fitting 14 along an outer surface of flexible heating element 16.

Fitting 14 can be formed of multiple components as shown in FIG. 1 assembled to position flexible heating element 16 as desired for electrical connection. As illustrated, fitting 14 can have a T fitting 40 including fluid inlet connection 38, hose connection 24, and passage 26. Fluid inlet connection 38 and hose connection 24 together provide a horizontal passage aligned with hose core 20. Passage 26 is positioned between fluid inlet connection 28 and hose connection 24 and oriented perpendicular to hose core 20. T fitting 40 is configured such that flexible heating element 16 forms a 90 degree elbow between passage 26 and hose core 20. Fitting 14 can include an additional fitting 42 configured to bend flexible heating element 16 another 90 degrees within fitting 14 such that flexible heating element 16 exits fitting 14 in an orientation parallel and overlapping with the portion of flexible heating element 16 disposed in hose core 20. It will be understood by one of ordinary skill in the art that fitting 14 is not limited to the embodiment disclosed herein and can have any configuration suitable for positioning flexible heating element 16 in hose core 20, retaining flexible heating element 16 in fitting 14, and forming a seal around an outer surface of flexible heating element 16 to prevent leakage of fluid from hose core 20 along an outer surface of heating element 14 out through fitting 14.

Ends of flexible heating element 16 extending from fitting 14 and a fitting (not shown) at the opposite end of hose 12 can include an electrical connection (not shown) configured to provide electrical current to heating element 16 when connected to a source of electrical power.

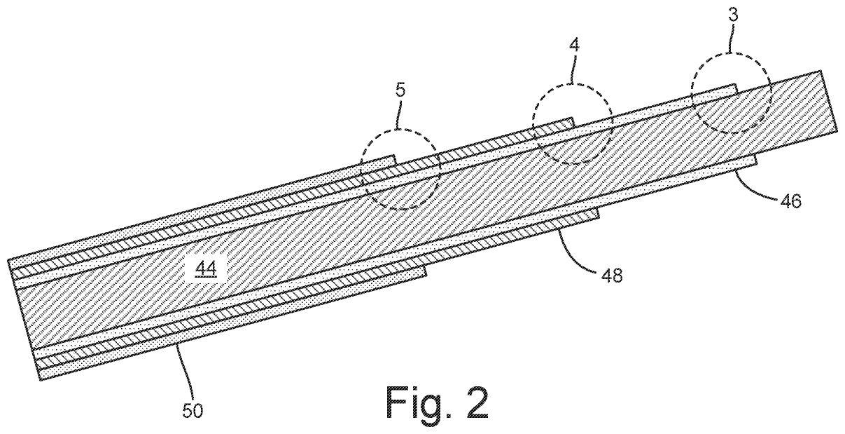

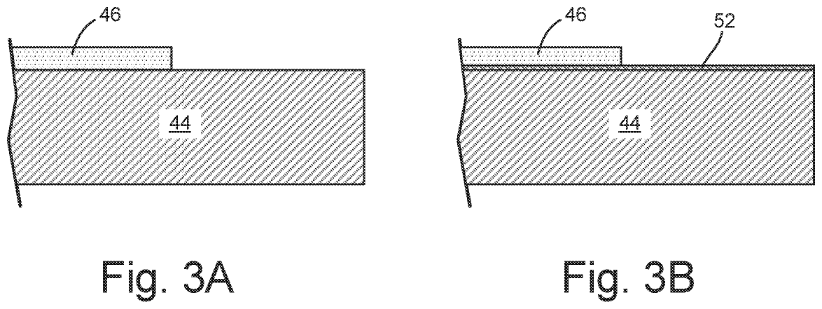

FIG. 2 is close-up cross-sectional view of a portion of flexible heating element 16. Flexible heating element 16 can be formed of a multi-layer construction including flexible heating wire 44 and insulating layer 46. As shown in FIG. 2, flexible heating element 16 can additionally include reinforcing layer 48 and protective layer 50. Portions of each of insulating layer 46, reinforcing layer 48, and protective layer 50 are cut away in FIG. 2 to illustrate the multi-layer construction. Each layer 46, 48, 50 forms a sheath that extends a full length of flexible heating wire 44. Reinforcing layer 48 and protection layer 50 are optional layers, which can be included to provide additional protection for flexible heating element 16. Flexible heating element 16 additionally includes sealant 52 (shown in FIGS. 3B, 4B, and 5B) disposed within and between layers as further described below. Sealant 52 can extend a partial length of flexible heating element 16 forming a sealed portion extending from an end of flexible heating element 16 located outside of fitting 14 to a location of flexible heating element 16 positioned in fitting 14 or hose core 20, such as location 54. In other examples, sealant 52 can extend a full length of flexible heating element 16.

Flexible heating element 16 includes flexible heating wire 44 and insulating layer 46. Flexible heating wire 44 is a conductive wire capable of conducting heat when supplied with an electrical current. Insulating layer 46 is a thermally conductive electrical insulator. Electrical power can be supplied to heating wire 44, which can conduct heat to fluid in hose core 20 during operation. Flexible heating wire 44 can be a metallic conductor, such as copper or other metal selected based on a desired resistance or heating capacity. Flexible heating wire 44 can include multiple strands of wire that collectively serve as a resistive heating element. A diameter of flexible heating wire 44 can vary depending on the application and diameter of hose core 20. In one example, flexible heating wire 44 can have a diameter of about 0.13 in. (0.3 cm). Flexible heating wire 44 can extend a full length of hose 12 (e.g., 50 feet (15 meters)) to provide heat to the fluid through the length of hose 12.

Electrical power can be supplied on continuous or an intermittent, as-needed, basis to maintain a desired temperature of a fluid within hose core 20. In some embodiments, the supply of electrical power can be controlled by one or more temperature sensors (not shown) configured to respond to the temperature of the fluid flowing through hose 12.

Insulating layer 46 is an electrical insulator. Insulating layer 46 can form a sheath around flexible heating wire 44 along a full length of flexible heating wire 44 disposed in hose core 20. Insulating layer 46 can be a thermally conductive material, such that flexible heating wire 44 dissipates the electrical power in the form of heat through insulating layer 46 and into fluid in hose core 20. Insulating layer 44 can be a polymer, including but not limited to ETFE, PTFE, PVC, FEP, or XLPE.

In some embodiments, flexible heating element 16 can further include reinforcing layer 48. Reinforcing layer 48 can form a sheath around insulating layer 46. Reinforcing layer 48 can be configured to provide flexible heating element 16 with additional tensile strength and abrasion resistance. Reinforcing layer 48 can be a stainless steel braided sleeve. Reinforcing layer 48 can extend the full length of flexible heating element 16.

In some embodiments, flexible heating element 16 can further include protective layer 50. Protective layer 50 can provide additional protection for flexible heating element 16. Specifically, protective layer 50 can further protect flexible heating wire 44 from contacting fluid in hose core 20. Protective layer 50 can form a sheath around reinforcing layer 48 and can extend a full length of flexible heating element 16. Protective layer 50 can form an outermost jacket for flexible heating element 16. Protective layer 50 can be formed of a polymer, such as ETFE, PTFE, PVC, FEP, or XLPE.

FIGS. 3A and 3B are close-up cross-sectional views of portions of flexible heating element 16 with and without sealant applied between flexible heating wire 44 and insulating layer 46. FIG. 3A illustrates an unsealed portion of flexible heating element 16 in which an interface between flexible heating wire 44 and insulating layer 46 is unsealed or at least partially open thereby allowing for fluid movement in the event of fluid leakage through insulating layer 46 from hose core 20. FIG. 3B illustrates a sealed portion of flexible heating element 16. As illustrated in FIG. 3B, sealant 52 is disposed between flexible heating wire 44 and insulating layer 46 to seal a leak path therebetween. Additionally, sealant 52 can fill gaps in heating wire 44, such as spaces formed between strands of wire (not shown).

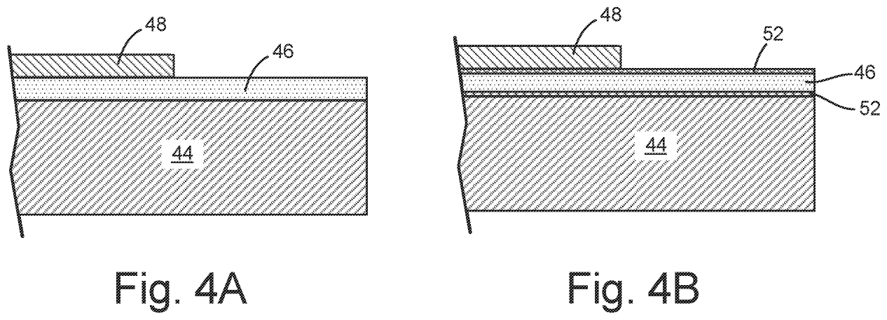

FIGS. 4A and 4B are close-up cross-sectional views of portions of flexible heating element 16 with and without sealant applied between insulating layer 46 and reinforcing layer 48 and between insulating layer 46 and flexible heating wire 44. FIG. 4A illustrates an unsealed portion of flexible heating element 16 in which interfaces between flexible heating wire 44 and insulating layer 46 and between insulating layer 46 and reinforcing layer 48 are unsealed or at least partially open thereby allowing for fluid movement in the event of fluid leakage through reinforcing layer 48 and insulating layer 46 from hose core 20. FIG. 4B illustrates a sealed portion of flexible heating element 16. As illustrated in FIG. 4B, sealant 52 is disposed between flexible heating wire 44 and insulating layer 46 to seal a leak path therebetween and between insulating layer 46 and reinforcing layer 48 to seal a leak path therebetween. As previously noted, sealant 52 can additionally fill gaps in heating wire 44, such as spaces formed between strands of wire (not shown). Additionally, sealant 52 can fill gaps in reinforcing layer 48, such as between strands of the braided sleeve (not shown).

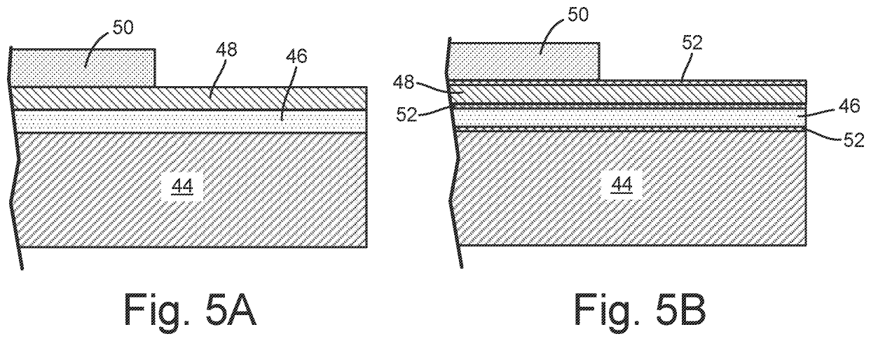

FIGS. 5A and 5B are close-up cross-sectional views of portions of flexible heating element 16 with and without sealant applied between protective layer 50 and reinforcing layer 48, between reinforcing layer 48 and insulating layer 46, and between insulating layer 46 and flexible heating wire 44. FIG. 5A illustrates an unsealed portion of flexible heating element 16 in which interfaces between flexible heating wire 44 and insulating layer 46, between insulating layer 46 and reinforcing layer 48, and between reinforcing layer 48 and protective layer 50 are unsealed or at least partially open thereby allowing for fluid movement in the event of fluid leakage through protective layer 50, reinforcing layer 48, and insulating layer 46 from hose core 20. FIG. 5B illustrates a sealed portion of flexible heating element 16. As illustrated in FIG. 5B, sealant 52 is disposed between flexible heating wire 44 and insulating layer 46 to seal a leak path therebetween, between insulating layer 46 and reinforcing layer 48 to seal a leak path therebetween, and between reinforcing layer 48 and protective layer 50 to seal a leak path therebetween. As previously noted, sealant 52 can additionally fill gaps in heating wire 44, such as spaces formed between strands of wire (not shown) and can fill gaps in reinforcing layer 48, such as between strands of the braided sleeve (not shown).

Sealant 52 can be an anaerobic sealant capable of curing in absence of air. Sealant 52 can be a thin, low viscosity, material capable of filling gaps within materials and between layer interfaces via capillary action. Sealant 52 can be, for example, a Loctite® sealant as known in the art. Sealant 52 is thermally conductive.

As illustrated in FIG. 1, sealed portions of flexible heating element 16 as illustrated in FIGS. 3B, 4B, and 5B can extend from an end of flexible heating element 16 located outside of fitting 14 to location of flexible heating element 16 positioned in fitting 14 or in hose core 20, such as location 54 in hose core 20. The sealed portion of flexible heating element 16 extends from outside fitting 14 to a location inside fitting 14 at least beyond retention element 32, which seals an outer surface of flexible heating element 16. The combination of sealant 52 and retention element 32 thereby prevents leakage of fluid from hose core 20 out through fitting 14. Retention element 32 prevents leakage of fluid from hose core 20 between the outer surface of flexible heating element 16 and retention element 32, while sealant 52 prevents leakage of fluid from hose core 20 between or through any materials or layers 44, 46, 48, 50. Although not shown, sealant 52 can be applied to an opposite end of flexible heating element 16 in the same manner as described with respect to the end of flexible heating element 16 illustrated in FIG. 1. In the absence of sealant 52, fluid from hose core 20 that penetrates materials or interfaces between layers 44, 46, 48, and 50 can migrate through heating element 16 out of hose core 20 and fitting 14 to electrical connections and other components external to hose 12, where the fluid can cause damage to internally heated hose assembly 10. While FIG. 1 shows sealed and unsealed portions of flexible heating element 16, in other examples, sealant 52 can extend a full length of flexible heating element 16.

During operation of internally heated hose assembly 10, flexible heating element 16 can be subjected to abrasive materials or materials capable of cutting through one or more layers surrounding flexible heating wire 44. Additionally, thermal cycling and flexing, as well variation in the manufacturing process of the materials, can contribute to wear. This can cause openings can form through an outermost layer of flexible heating element 16 into one or more inner layers or to flexible heating wire 44. For example, a flexible heating element 16 having flexible heading wire 44 and insulating layer 46 can be subjected to abrasive materials, which can cut through insulating layer 46 providing a pathway for fluid from hose core 20 to flexible heating wire 44. In an unsealed portion of flexible heating element 16, fluid from hose core 20 can leak into the interface between flexible heating wire 44 and insulating layer 46 and can travel axially along that interface in both directions. In the absence of sealant 52, fluid leaked from hose core 20 can travel through flexible heating element 16 out through fitting 14. The sealed section of flexible heating element 16 formed with sealant 52 can block fluid thereby preventing fluid leaked from hose core 20 from reaching an end of flexible heating element 16 outside of fitting 14. Sealant 52 effectively forms a solid cross-section throughout the sealed portion of flexible heating element 16 thereby blocking any leakage pathways in the unsealed portion of flexible heating element 16.

Flexible heating element 16 can be sealed by injecting sealant 52 through open ends of flexible heating element 16 such that sealant 52 can migrate along a length of flexible heating element 16 through interfaces between flexible heating wire 44 and insulating layer 46, and when present, between insulating layer 46 and reinforcing layer 48, and between reinforcing layer 48 and protective layer 50. Sealant 52 can also fill gaps that may exist within each material layer, such as between strands of heating wire or braided reinforcing strands. Capillary action can draw sealant 52 through layer interfaces and into material voids. Sealant 52 can be an anaerobic sealant material capable of curing in the absence of air. Sealant 52 can cure to effectively form a solid or sealed section having no connected porosity through which a fluid from hose core 20 could leak.

In some embodiments, an unsealed flexible heating element 16 can be loosely assembled in fitting 14 and hose core 20 and sealant 52 can be injected into open ends of flexible heating element 16 extending outside of fitting 14 and a fitting disposed on the opposite end of hose 12. A fitting of a small hose (not shown) can be secured and sealed around the outer surface of the ends of flexible heating element 16 to confine injection of sealant 52 to within the layers of flexible heating element 16 and to limit flow of sealant 52 along the outer surface of flexible heating element 16. A pressure pump can be used to inject sealant 42 into flexible heating element 16. To ensure that sealant 52 extends at least beyond retention element 32, sealant 52 can be injected until visible in a portion of flexible heating element 16 located in hose core 20, which is viewable through fluid inlet connection 38 of fitting 14. Sealant 52 can include a fluorescent material, which can be viewable with an ultraviolet light if shown through fluid inlet connection 38. Once sealant 52 has cured, retention element 32 can form a seal (e.g., via compression) around the outer surface of flexible heating element 16 by tightening retention mechanism 30 thereby blocking all leakage paths from hose core 20. Both ends of flexible heating element 16 can be sealed as described to prevent leakage of fluid from hose core 20 via flexible heating element 16. It is unnecessary to seal the entire length of flexible heating element 16, as any leakage occurring in unsealed portions of flexible heating element 16 will be blocked by sealed portions and will remain in hose core 20.

The disclosed internally heated hose assembly with a flexible heating element formed in-part of a sealed multi-layer construction can be used to heat fluids in a hose while preventing fluids from leaking out of the hose through the flexible heating element, particularly at locations of fittings or electrical connections.

### Discussion of Possible Embodiments

The following are non-exclusive descriptions of possible embodiments of the present invention.

An internally heated hose includes a multi-layer flexible heating element including a sealant material disposed between layers of the multi-layer flexible heating element, a hose core through which the multi-layer flexible heating element extends, and a fitting coupled to the hose core and through which the multi-layer flexible heating element extends. The fitting is configured to secure the multi-layer flexible heating element in place and mechanically seal an outer surface of the multi-layer flexible heating element.

The internally heated hose of the preceding paragraph can optionally include, additionally and/or alternatively, any one or more of the following features, configurations and/or additional components:

The internally heated hose of the preceding paragraph, wherein the multi-layer flexible heating element includes a conductive wire, and an insulating layer forming a sheath around the conductive wire, and wherein the sealant material is disposed between the conductive wire and the insulating layer to seal a leak path therebetween.

The internally heated hose of any of the preceding paragraphs, wherein the insulating layer is a polymer.

The internally heated hose of any of the preceding paragraphs, wherein the multi-layer flexible heating element further comprises a reinforcing layer forming a sheath around the insulating layer, wherein the sealant material is further disposed between the reinforcing layer and the insulating layer to seal a leak path therebetween.

The internally heated hose of any of the preceding paragraphs, wherein the reinforcing layer is a stainless-steel braid and wherein the sealant material fills voids in the stainless-steel braid.

The internally heated hose of any of the preceding paragraphs, wherein the multi-layer flexible heating element further comprises a protective layer forming a sheath around the reinforcing layer, wherein the sealant material is further disposed between the protective layer and the reinforcing layer to seal a leak path therebetween.

The internally heated hose of any of the preceding paragraphs, wherein the protective layer is a polymer.

The internally heated hose of any of the preceding paragraphs, wherein the sealant material extends a partial length of the multi-layer flexible heating element, forming a sealed portion.

The internally heated hose of any of the preceding paragraphs, wherein the fitting comprises a mechanical sealing element disposed around an outer surface of the sealed portion of multi-layer flexible heating element.

The internally heated hose of any of the preceding paragraphs, wherein the sealed portion of the multi-layer flexible heating element extends beyond the mechanical sealing element to location inside the fitting.

The internally heated hose of any of the preceding paragraphs, wherein the sealed portion of the multi-layer flexible heating element extends to a location of the multi-layer flexible heating element positioned in the hose core.

The internally heated hose of any of the preceding paragraphs, wherein the sealed portion is a first sealed portion extending from a first end of the multi-layer flexible heating element and wherein the multi-layer flexible heating element further comprises a second sealed portion extending from a second end of the flexible heating element, the second sealed portion formed by the sealant material.

The internally heated hose of any of the preceding paragraphs, wherein the sealant material is an anaerobic sealant configured to cure in the absence of air.

A flexible heating element for an internally heated hose includes a conductive wire, an insulating layer forming a sheath around the conductive wire, and a sealant material disposed between the conductive wire and the insulating layer to seal a leak path therebetween.

The internally heated hose of the preceding paragraph can optionally include, additionally and/or alternatively, any one or more of the following features, configurations and/or additional components:

The flexible heating element of the preceding paragraph, wherein the insulating layer is a polymer.

The flexible heating element of any of the preceding paragraphs, and further comprising a reinforcing layer forming a sheath around the insulating layer, wherein the sealant material is further disposed between the reinforcing layer and the insulating layer to seal a leak path therebetween.

The flexible heating element of any of the preceding paragraphs, wherein the reinforcing layer is a stainless-steel braid and wherein the sealant material fills voids in the stainless-steel braid.

The flexible heating element of any of the preceding paragraphs, and further comprising a protective layer forming a sheath around the reinforcing layer, wherein the sealant material is further disposed between the protective layer and the reinforcing layer to seal a leak path therebetween.

The flexible heating element of any of the preceding paragraphs, wherein the protective layer is a polymer.

The flexible heating element of any of the preceding paragraphs, wherein the sealant material extends a partial length of the flexible heating element, forming a sealed portion.

The flexible heating element of any of the preceding paragraphs, wherein the sealed portion is a first sealed portion extending from a first end of the flexible heating element and wherein the flexible heating element further comprises a second sealed portion extending from a second end of the flexible heating element, the second sealed portion formed by the sealant material.

The flexible heating element of any of the preceding paragraphs, and further comprising an unsealed portion disposed between the first and second sealed portions.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An internally heated hose comprising:
a multi-layer flexible heating element comprising a sealant material disposed between layers of the multi-layer flexible heating element;
a hose core through which the multi-layer flexible heating element extends; and
a fitting coupled to the hose core and through which the multi-layer flexible heating element extends, the fitting configured to secure the multi-layer flexible heating element in place and mechanically seal an outer surface of the multi-layer flexible heating element.

2. The internally heated hose of claim 1, wherein the multi-layer flexible heating element comprises:
a conductive wire; and
an insulating layer forming a sheath around the conductive wire;
wherein the sealant material is disposed between the conductive wire and the insulating layer to seal a leak path therebetween.

3. (canceled)

4. The internally-heated hose of claim 2, wherein the multi-layer flexible heating element further comprises a reinforcing layer forming a sheath around the insulating layer, wherein the sealant material is further disposed between the reinforcing layer and the insulating layer to seal a leak path therebetween.

5. The internally heated hose of claim 4, wherein the reinforcing layer is a stainless-steel braid and wherein the sealant material fills voids in the stainless-steel braid.

6. The internally-heated hose of claim 4, wherein the multi-layer flexible heating element further comprises a protective layer forming a sheath around the reinforcing layer, wherein the sealant material is further disposed between the protective layer and the reinforcing layer to seal a leak path therebetween.

7. The internally heated hose of claim 6, wherein at least one of the protective layer and the insulating layer is a polymer.

8. The internally heated hose of claim 6, wherein the sealant material extends a partial length of the multi-layer flexible heating element, forming a sealed portion.

9. The internally heated hose of claim 8, wherein the fitting comprises a mechanical sealing element disposed around an outer surface of the sealed portion of multi-layer flexible heating element.

10. The internally heated hose of claim 9, wherein the sealed portion of the multi-layer flexible heating element extends beyond the mechanical sealing element to a location inside the fitting.

11. The internally heated hose of claim 10, wherein the sealed portion of the multi-layer flexible heating element extends to a location of the multi-layer flexible heating element positioned in the hose core.

12. The internally heated hose of claim 10, wherein the sealed portion is a first sealed portion extending from a first end of the multi-layer flexible heating element and wherein the multi-layer flexible heating element further comprises a second sealed portion extending from a second end of the flexible heating element, the second sealed portion formed by the sealant material.

13. The internally heated hose of claim 1, wherein the sealant material is an anaerobic sealant configured to cure in the absence of air.

14. A flexible heating element for an internally heated hose, the flexible heating element comprising:
a conductive wire;
an insulating layer forming a sheath around the conductive wire; and
a sealant material disposed between the conductive wire and the insulating layer to seal a leak path therebetween.

15. (canceled)

16. The flexible heating element of claim 14, and further comprising a reinforcing layer forming a sheath around the insulating layer, wherein the sealant material is further disposed between the reinforcing layer and the insulating layer to seal a leak path therebetween.

17. The flexible heating element of claim 16, wherein the reinforcing layer is a stainless-steel braid and wherein the sealant material fills voids in the stainless-steel braid.

18. The flexible heating element of claim 16, and further comprising a protective layer forming a sheath around the reinforcing layer, wherein the sealant material is further disposed between the protective layer and the reinforcing layer to seal a leak path therebetween.

19. The flexible heating element of claim 18, wherein at least one of the protective layer and the insulating layer is a polymer.

20. The flexible heating element of claim 18, wherein the sealant material extends a partial length of the flexible heating element, forming a sealed portion.

21. The flexible heating element of claim 20, wherein the sealed portion is a first sealed portion extending from a first end of the flexible heating element and wherein the flexible heating element further comprises a second sealed portion extending from a second end of the flexible heating element, the second sealed portion formed by the sealant material.

22. The flexible heating element of claim 21, and further comprising an unsealed portion disposed between the first and second sealed portions.
